(19) United States
(12) Patent Application Publication
(10) Pub. No.: US 2014/0078196 A1
(43) Pub. Date: Mar. 20, 2014

(54) DRIVE CIRCUIT AND DRIVE METHOD FOR DISPLAY DEVICE

(71) Applicants: Kouji Kumada, Osaka-shi (JP); Noriyuki Tanaka, Osaka-shi (JP); Tatsuhiko Suyama, Osaka-shi (JP)

(72) Inventors: Kouji Kumada, Osaka-shi (JP); Noriyuki Tanaka, Osaka-shi (JP); Tatsuhiko Suyama, Osaka-shi (JP)

(73) Assignee: SHARP KABUSHIKI KAISHA, Osaka-shi, Osaka (JP)

(21) Appl. No.: 14/118,937

(22) PCT Filed: May 24, 2012
(86) PCT No.: PCT/JP2012/063295

§ 371 Date: Nov. 20, 2013

(30) Foreign Application Priority Data
May 31, 2011 (JP) 2011-121296

(51) Int. Cl. G09G 3/36

(52) U.S. Cl. CPC G09G 3/3685
USPC 345/691; 345/87

(57) ABSTRACT

An object of the invention of the present application is to drive data signal lines accurately by pulse width modulation driving and display gradations accurately. A PWM pattern generating circuit (12) generates 2^{q} sets of PWM patterns associated with combinations of a gradation and the polarity of a gradation voltage. A selector (15) selects one PWM pattern from among the 2^{p+q} PWM patterns, based on gradation data and a pattern set number. A charge and discharge control circuit (16) controls a charge and discharge circuit (17) to apply a charge voltage and a discharge voltage to a data signal line in a switching manner, based on the selected PWM pattern. One correction pulse may be selected for each data signal line from among a plurality of types of generated correction pulses, and a charge voltage may be applied to the data signal line based on the correction pulse. A plurality of charging transistors may be provided, and a charging transistor to be used may be specified for each data signal line, according to the temperature.

### TECHNICAL FIELD

The present invention relates to a display device such as a liquid crystal display device, and more particularly to a drive circuit and a drive method that drive data signal lines of a display device.

### BACKGROUND ART

Liquid crystal display devices have features such as low profile and low power consumption, and are used for various applications. Liquid crystal display devices are also used in, for example, battery operating portable devices. In recent years, even for the display screens of portable devices, an increase in screen size and an increase in resolution have been advanced. With the advancement of an increase in screen size and an increase in resolution, the load on a drive circuit of a liquid crystal panel increases and thus the operating frequency of the drive circuit increases. Due to this, the power consumption of a liquid crystal display device increases. Hence, in order to suppress the battery size of portable devices, a further reduction in power consumption is required for liquid crystal display devices.

The power consumption of a liquid crystal display device is broadly divided into the power consumption of a liquid crystal panel (power consumption by charging and discharging) and the power consumption of a drive circuit. Methods for reducing the power consumption of the drive circuit will be considered below. The power consumption of the drive circuit can be reduced by devising the circuit configuration. For example, by reducing analog circuits through which a steady-state current flows, the power consumption of the drive circuit can be reduced.

In a conventional general liquid crystal display device, data signal lines (also called video signal lines, source bus lines, etc.) are driven using a drive circuit including analog buffer circuits. Since a steady-state current flows through the analog buffer circuits, the analog buffer circuits become a factor for increasing in the power consumption of the liquid crystal display device. In view of this, as a method for driving the data signal lines without using analog buffer circuits, there is conventionally known a method in which only two types of voltages (a charge voltage and a discharge voltage) are applied to a data signal line in a switching manner, and the lengths of times during which the two types of voltages are applied are changed according to a video signal (hereinafter, referred to as pulse width modulation driving).

Concerning the pulse width modulation driving, Patent Document 1 describes a method in which a voltage that is lower than a voltage applied to a data signal line is written to pixels, and a method in which a gradation is displayed by shifting the waveforms of a scanning signal line and a data signal line, and the polarity of pixels in a data signal line direction is reversed alternately. Patent Document 2 describes a method in which when pulse width modulation driving is performed, the difference between the voltage on a scanning signal line and the voltage on a data signal line is made equal between positive polarity writing and negative polarity writing. Patent Document 3 describes, as a data signal line drive method other than pulse width modulation driving, a method in which a voltage having oscillation components which oscillate during one horizontal period is applied to a data signal line.

### PRIOR ART DOCUMENTS

### Patent Documents

[Patent Document 1] Japanese Laid-Open Patent Publication No. 2001-356745
[Patent Document 2] Japanese Laid-Open Patent Publication No. 2003-248465
[Patent Document 3] Japanese Laid-Open Patent Publication No. 6-27900

### SUMMARY OF THE INVENTION

### Problems to be Solved by the Invention

By performing pulse width modulation driving, the analog buffer circuits included in the data signal line drive circuit are removed, by which the power consumption of the display device can be reduced. However, in general, there are variations in the time constant at charging of the data signal lines. Due to this, even if a charge voltage is applied to two data signal lines for the same length of time, a difference may occur in reached voltage between the data signal lines. The difference appears as a luminance difference in the display screen. As such, pulse width modulation driving has a problem that when there are variations in the time constant at charging of the data signal lines, the data signal lines cannot be driven accurately. This problem becomes noticeable in a display device having a large number of data signal lines and having a large number of gradations.

Patent Documents 1 and 2 do not describe any method for solving this problem. In addition, in the method described in Patent Document 3, since the voltage on a data signal line is oscillated, charging and discharging of a load capacitance are performed frequently, resulting in wasteful power consumption. In addition, the method described in Patent Document 3 has a problem that the method cannot handle a display device having a large number of gradations.

An object of the present invention is therefore to provide a drive circuit that drives data signal lines accurately using pulse width modulation driving, and a display device that displays gradations accurately using the drive circuit.

### Means for Solving the Problems

According to a first aspect of the present invention, there is provided a drive circuit that drives data signal lines of a display device, the drive circuit including: a pattern generating circuit that generates, for each gradation, a plurality of sets of patterns having a pulse width according to the gradation; a selecting circuit that selects one pattern from among the patterns generated by the pattern generating circuit, based on gradation data provided to each of the data signal lines and a set of patterns specified for each of the data signal lines; a charge and discharge control circuit that obtains a charge control signal and a discharge control signal, based on the pattern selected by the selecting circuit; and a charge and discharge circuit that applies a charge voltage and a discharge voltage to the data signal line in a switching manner, according to the charge control signal and the discharge control signal.

According to a second aspect of the present invention, in the first aspect of the present invention, the charge and discharge circuit includes a charging transistor that applies the charge voltage to the data signal line, according to the charge control signal; and a discharging transistor that applies the discharge voltage to the data signal line, according to the discharge control signal.

According to a third aspect of the present invention, in the second aspect of the present invention, the drive circuit further includes a correction pulse generating circuit that generates a plurality of types of correction pulses each having a predetermined width, wherein the charge and discharge control circuit selects one correction pulse specified for each of the data signal lines from among the correction pulses generated by the correction pulse generating circuit, and changes the charge control signal to a level that instructs charging, based on the selected correction pulse.

According to a fourth aspect of the present invention, in the second aspect of the present invention, the charge and discharge circuit includes a plurality of charging transistors and uses, at charging, one or more transistors specified for each of the data signal lines from among the plurality of charging transistors, according to a temperature.

According to a fifth aspect of the present invention, in the second aspect of the present invention, during a voltage holding period set in one horizontal period, the charge and discharge control circuit controls both of the charging transistor and the discharging transistor to an OFF state.

According to a sixth aspect of the present invention, in the second aspect of the present invention, the charge and discharge control circuit outputs a first control signal and a second control signal, the first control signal being the charge control signal during a first period and being the discharge control signal during a second period, and the second control signal being the discharge control signal during the first period and being the charge control signal during the second period, and the charge and discharge circuit includes a first transistor that functions as the charging transistor or the discharging transistor according to the first control signal; and a second transistor that functions as the discharging transistor or the charging transistor according to the second control signal.

According to a seventh aspect of the present invention, in the sixth aspect of the present invention, the charge and discharge circuit includes a plurality of first transistors and a plurality of second transistors, and uses, at charging during the first period, one or more transistors specified for each of the data signal lines from among the plurality of first transistors, according to a temperature, and uses, at charging during the second period, one or more transistors specified for each of the data signal lines from among the plurality of second transistors, according to the temperature.

According to an eighth aspect of the present invention, in the first aspect of the present invention, charge time during one horizontal period of each of the data signal lines is twice a time constant at charging of the data signal line or less.

According to a ninth aspect of the present invention, in the first aspect of the present invention, charge time during one horizontal period of each of the data signal lines is 2.3 times a time constant at charging of the data signal line or less.

According to a tenth aspect of the present invention, in the first aspect of the present invention, one horizontal period is 4.5 times a time constant at charging of the data signal lines or more.

According to an eleventh aspect of the present invention, there is provided a display device that performs gradation display, the display device including: a display panel including a plurality of scanning signal lines, a plurality of data signal lines, and a plurality of pixel circuits; a scanning signal line drive circuit that selects the scanning signal lines in turn; and a data signal line drive circuit that applies gradation voltages according to a video signal, to the data signal lines, wherein the data signal line drive circuit includes: a pattern generating circuit that generates, for each gradation, a plurality of sets of patterns having a pulse width according to the gradation; a selecting circuit that selects one pattern from among the patterns generated by the pattern generating circuit, based on gradation data provided to each of the data signal lines and a set of patterns specified for each of the data signal lines; a charge and discharge control circuit that obtains a charge control signal and a discharge control signal, based on the pattern selected by the selecting circuit; and a charge and discharge circuit that applies a charge voltage and a discharge voltage to the data signal line in a switching manner, according to the charge control signal and the discharge control signal.

According to a twelfth aspect of the present invention, there is provided a drive method for driving data signal lines of a display device, the method including the steps of: generating, for each gradation, a plurality of sets of patterns having a pulse width according to the gradation; selecting one pattern from among the generated patterns, based on gradation data provided to each of the data signal lines and a set of patterns specified for each of the data signal lines; obtaining a charge control signal and a discharge control signal, based on the selected pattern; and applying a charge voltage and a discharge voltage to the data signal line in a switching manner, according to the charge control signal and the discharge control signal.

According to a thirteenth aspect of the present invention, there is provided a drive method for a display device that includes a display panel having a plurality of scanning signal lines, a plurality of data signal lines, and a plurality of pixel circuits, and that performs gradation display, the method including the steps of: selecting the scanning signal lines in turn; generating, for each gradation, a plurality of sets of patterns having a pulse width according to the gradation; selecting one pattern from among the generated patterns, based on gradation data provided to each of the data signal lines and a set of patterns specified for each of the data signal lines; obtaining a charge control signal and a discharge control signal, based on the selected pattern; and applying a charge voltage and a discharge voltage to the data signal line in a switching manner, according to the charge control signal and the discharge control signal.

### Effects of the Invention

According to the first or twelfth aspect of the present invention, a plurality of sets of patterns associated with each gradation are generated, and which set of patterns to use is selected for each data signal line. By this, even when there are variations in the time constant at charging of the data signal lines, the data signal lines can be driven accurately using a suitable pattern for each data signal line.

According to the second aspect of the present invention, a charge and discharge circuit that applies a charge voltage and a discharge voltage to a data signal line in a switching manner can be configured using a charging transistor and a discharging transistor.

According to the third aspect of the present invention, a plurality of types of correction pulses are generated, and which correction pulse to use is selected for each data signal line. By this, even when the voltage on a data signal line changes due to a leakage current, by making a correction using a suitable correction pulse for each data signal line, the data signal lines can be driven accurately.

According to the fourth aspect of the present invention, a plurality of charging transistors are provided, and which charging transistor to use is selected for each data signal line, according to the temperature. By this, even when the temperature is changed, by using a suitable charging transistor for each data signal line, the data signal lines can be driven accurately.

According to the fifth aspect of the present invention, by providing a voltage holding period in one horizontal period, the voltage on a data signal line can be written securely to a pixel circuit connected to the data signal line.

According to the sixth aspect of the present invention, a charge and discharge circuit that applies a charge voltage and a discharge voltage to a data signal line in a switching manner can be configured using a first and a second transistor.

According to the seventh aspect of the present invention, a plurality of first transistors and a plurality of second transistors are provided, and which transistor to use as a charging transistor is selected for each data signal line, according to the temperature. By this, even when the temperature is changed, by using a suitable charging transistor for each data signal line, the data signal lines can be driven accurately.

According to the eighth or ninth aspect of the present invention, by setting the charge time during one horizontal period of a data signal line to twice the time constant at charging of the data signal line or less, or 2.3 times the time constant or less, wasted charge time is reduced, enabling to use time effectively.

According to the tenth aspect of the present invention, by setting one horizontal period to 4.5 times the time constant at charging of the data signal lines or more, sufficient time can be secured to allow the voltage on the data signal line to reach a plurality of levels during one horizontal period.

According to the eleventh or thirteenth aspect of the present invention, gradations can be displayed accurately using a drive circuit or a drive method that can drive the data signal lines accurately.

### BRIEF DESCRIPTION OF THE DRAWINGS

FIG. 1 is a block diagram showing a configuration of a liquid crystal display device according to a first embodiment of the present invention.

FIG. 2 is a diagram showing a configuration of a data signal line drive circuit of the liquid crystal display device shown in FIG. 1.

FIG. 3 is a signal waveform diagram of the data signal line drive circuit shown in FIG. 2.

FIG. 4 is a diagram showing a load model of a data signal line.

FIG. 5 is a diagram showing data stored in a PWM pattern generating circuit in the data signal line drive circuit shown in FIG. 2.

FIG. 6 is a diagram showing data stored in a PWM pattern specifying circuit in the data signal line drive circuit shown in FIG. 2.

FIG. 7 is a diagram showing a configuration of a data signal line drive circuit of a liquid crystal display device according to a second embodiment of the present invention.

FIG. 8 is a signal waveform diagram of the data signal line drive circuit shown in FIG. 7.

FIG. 9 is a diagram showing data stored in a correction pulse generating circuit in the data signal line drive circuit shown in FIG. 7.

FIG. 10 is a diagram showing data stored in a correction pulse specifying circuit in the data signal line drive circuit shown in FIG. 7.

FIG. 11 is a signal waveform diagram of a data signal line drive circuit that does not have a correction charge period.

FIG. 12 is a diagram showing a configuration of a data signal line drive circuit of a liquid crystal display device according to a third embodiment of the present invention.

FIG. 13 is a diagram showing data stored in a transistor specifying circuit in the data signal line drive circuit shown in FIG. 12.

FIG. 14 is a diagram showing a configuration of a data signal line drive circuit of a liquid crystal display device according to a fourth embodiment of the present invention.

FIG. 15 is a signal waveform diagram of the data signal line drive circuit shown in FIG. 14.

FIG. 16 is a diagram showing a charge and discharge circuit in a data signal line drive circuit according to a variant of the embodiments of the present invention.

### MODES FOR CARRYING OUT THE INVENTION

### First Embodiment

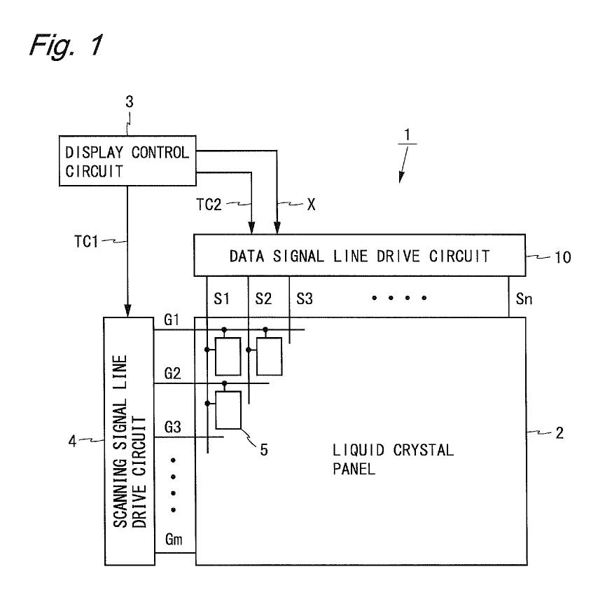

FIG. 1 is a block diagram showing a configuration of a liquid crystal display device according to a first embodiment of the present invention. A liquid crystal display device 1 shown in FIG. 1 includes a liquid crystal panel 2, a display control circuit 3, a scanning signal line drive circuit 4, and a data signal line drive circuit 10. The liquid crystal display device 1 performs 2^{p}-level (p is an integer greater than or equal to 2) gradation display, based on a video signal X outputted from the display control circuit 3. In the following, m is an integer greater than or equal to 1, n is an even number greater than or equal to 2, i is an odd number between 1 and n, inclusive, and j is an integer between 1 and n, inclusive.

The liquid crystal panel 2 includes m scanning signal lines G1 to Gm, n data signal lines S1 to Sn, and (m×n) pixel circuits 5. The scanning signal lines G1 to Gm are arranged parallel to one another. The data signal lines S1 to Sn are arranged parallel to one another so as to intersect with the scanning signal lines G1 to Gm perpendicularly. The scanning signal lines G1 to Gm and the data signal lines S1 to Sn intersect each other at (m×n) locations. A total of (m×n) pixel circuits 5 are arranged at the (m×n) intersections. Each pixel circuit 5 is connected to one scanning signal line and one data signal line.

The display control circuit 3 outputs a timing control signal TC1 to the scanning signal line drive circuit 4, and outputs a timing control signal TC2 and the video signal X to the data signal line drive circuit 10. The timing control signal TC1 includes, for example, a gate start pulse, a gate clock, etc. The timing control signal TC2 includes, for example, a source start pulse, a source clock, etc.

The scanning signal line drive circuit 4 selects the scanning signal lines G1 to Gm in turn, based on the timing control signal TC1. By this, n pixel circuits 5 connected to the selected scanning signal line are selected at a time. The data signal line drive circuit 10 applies gradation voltages according to the video signal X to the data signal lines S1 to Sn, based on the timing control signal TC2. By this, n gradation voltages are written to the n pixel circuits 5 selected by the scanning signal line drive circuit 4. The luminance of a pixel circuit 5 is determined by a gradation voltage written to the pixel circuit 5. By writing gradation voltages to all of the pixel circuits 5 using the scanning signal line drive circuit 4 and the data signal line drive circuit 10, an image can be displayed on the liquid crystal panel 2.

The liquid crystal display device 1 performs dot-reversal driving where the polarity of gradation voltages written to the pixel circuits 5 is reversed between adjacent pixel circuits 5. Writing positive polarity voltages (negative polarity voltages) to pixel circuits 5 connected to the odd-numbered (even-numbered) data signal lines is hereinafter referred to as first writing, and writing negative polarity voltages (positive polarity voltages) to pixel circuits 5 connected to the odd-numbered (even-numbered) data signal lines is hereinafter referred to as second writing. The data signal line drive circuit 10 performs the first writing and the second writing alternately every horizontal period.

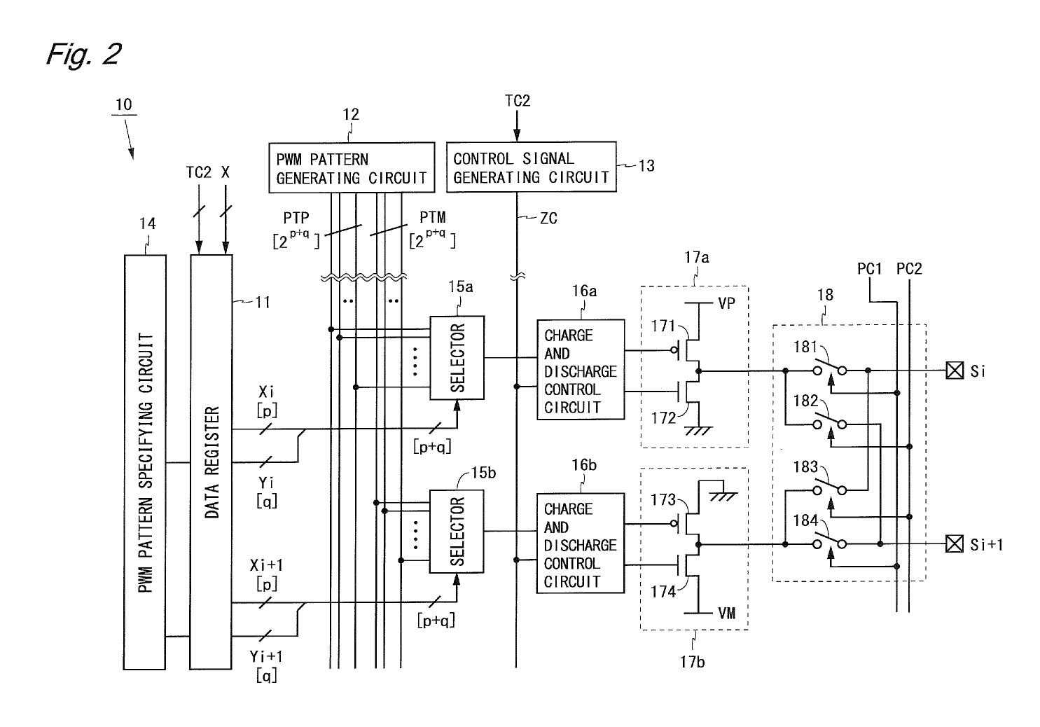

FIG. 2 is a diagram showing a configuration of the data signal line drive circuit 10. As shown in FIG. 2, the data signal line drive circuit 10 includes a data register 11, a PWM pattern generating circuit 12, a control signal generating circuit 13, a PWM pattern specifying circuit 14, n selectors 15, n charge and discharge control circuits 16, n charge and discharge circuits 17, and (n/2) polarity selecting circuits 18. For two adjacent data signal lines Si and Si+1, two selectors 15a and 15b, two charge and discharge control circuits 16a and 16b, two charge and discharge circuits 17a and 17b, and one polarity selecting circuit 18 are provided. Note that although FIG. 2 shows only circuits that drive the two data signal lines Si and Si+1, circuits that drive other data signal lines also have the same structure.

The video signal X outputted from the display control circuit 3 during one horizontal period includes n pieces of p-bit gradation data. Gradation data for a j-th data signal line Sj is hereinafter referred to as Xj. The display control circuit 3 may output gradation data one by one in turn or may output a plurality of gradation data at a time in turn.

The data register 11 stores n gradation data X1 to Xn outputted from the display control circuit 3, and outputs the gradation data X1 to Xn in parallel during one horizontal period. More specifically, the data register 11 includes two (n×p)-bit registers (not shown). The n gradation data outputted from the display control circuit 3 are written in turn to a first register. At the first writing, the n gradation data are written to the first register in their original order. At the second writing, the n gradation data are written to the first register such that the odd-numbered data and the even-numbered data are switched. After completion of the writing to the first register, the n gradation data are transferred at a time from the first register to a second register. The data register 11 outputs output signals from the second register. At the first writing, the data register 11 outputs the n gradation data in the order of X1, X2, X3, X4, . . . , Xn−1, and Xn. At the second writing, the data register 11 outputs the n gradation data in the order of X2, X1, X4, X3, . . . , Xn, and Xn−1. Note that FIG. 2 shows the state at the first writing.

The selectors 15a and 15b, the charge and discharge control circuits 16a and 16b, the charge and discharge circuits 17a and 17b, and the polarity selecting circuit 18 apply gradation voltages according to gradation data Xi and Xi+1 outputted from the data register 11, to the data signal lines Si and Si+1, respectively. The PWM pattern generating circuit 12, the control signal generating circuit 13, and the PWM pattern specifying circuit 14 output signals required for the operation of the selectors 15 and the charge and discharge control circuits 16.

The data signal line drive circuit 10 performs pulse width modulation driving where only two types of voltages (a charge voltage and a discharge voltage) are applied to a data signal line and the lengths of times during which the two types of voltages are applied are changed according to a video signal. The pulse width modulation driving performed by the data signal line drive circuit 10 is characterized by generating a plurality of sets of PWM (Pulse Width Modulation) patterns associated with gradations and the polarity (positive polarity or negative polarity) of gradation voltages, and selecting, for each data signal line, which set of PWM patterns to use (details will be described later).

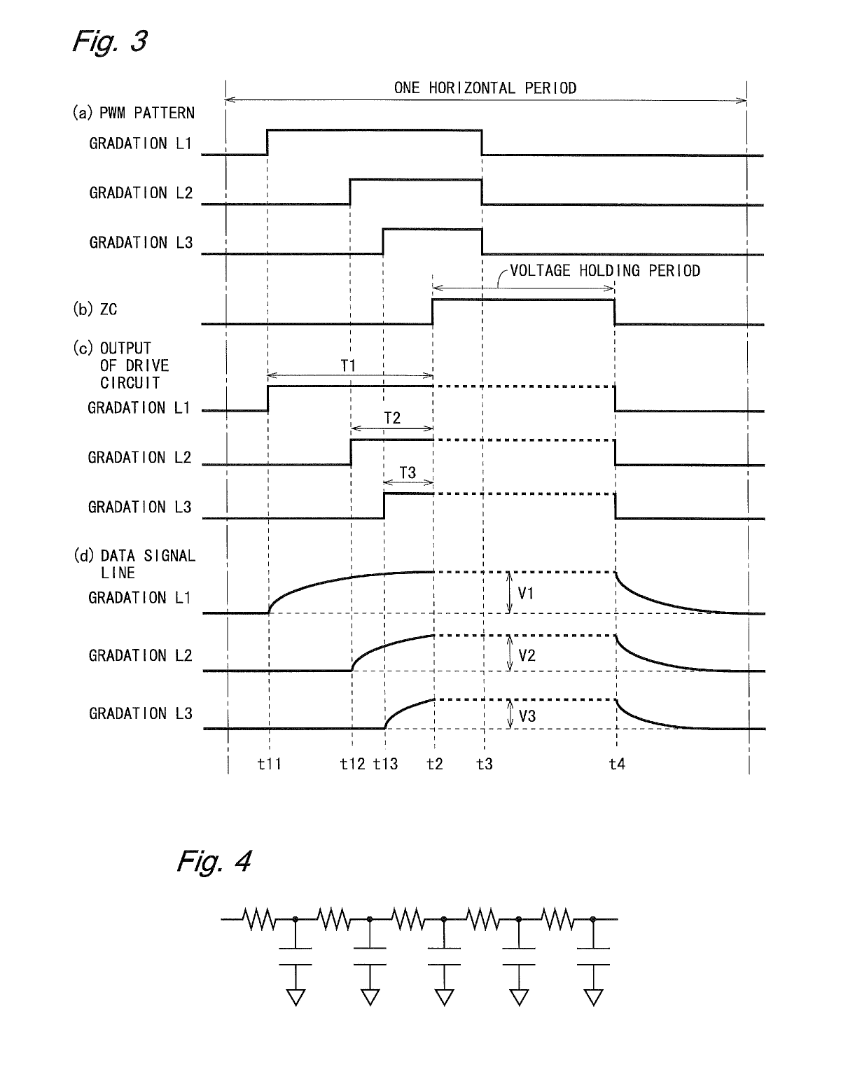

FIG. 3 is a signal waveform diagram of the data signal line drive circuit 10. With reference to FIGS. 2 and 3, the operation of the data signal line drive circuit 10 will be described. The PWM pattern generating circuit 12 generates a plurality of PWM patterns in association with combinations of each gradation and the polarity of a gradation voltage. The PWM patterns include positive-side PWM patterns PTP for positive polarity voltage and negative-side PWM patterns PTM for negative polarity voltage. FIG. 3 (a) shows three types of positive-side PWM patterns associated with gradations L1, L2, and L3. The PWM pattern generated by the data signal line drive circuit 10 changes to a high level at a predetermined time during one horizontal period (e.g., time t11 in case of gradation L1), and changes to a low level at time t3 during one horizontal period. The length of the high-level period of the PWM pattern is determined according to the gradation and the polarity of the gradation voltage.

The control signal generating circuit 13 outputs a control signal ZC, based on the timing control signal TC2 outputted from the display control circuit 3. As shown in FIG. 3 (b), the control signal ZC changes to a high level at time t2 during one horizontal period, and changes to a low level at time t4 during one horizontal period. Note, however, that time t2 is later than the latest time at which the PWM pattern changes to a high level, and is earlier than time t3. Time t4 is later than time t3. The period during which the control signal ZC is at a low level and the PWM pattern is at a high level is a charge period during which a charge voltage is applied to the data signal line. The period during which both the control signal ZC and the PWM pattern are at a low level is a discharge period during which a discharge voltage is applied to the data signal line. The period during which the control signal ZC is at a high level is a voltage holding period during which the data signal line is placed in a high impedance state. By providing the voltage holding period, the voltage on a data signal line Sj can be written securely to a corresponding pixel circuit 5.

At the first writing, the data register 11 outputs gradation data Xi to the selector 15a and outputs gradation data Xi+1 to the selector 15b. In addition to the gradation data Xi, a plurality of positive-side PWM patterns PTP generated by the PWM pattern generating circuit 12 are inputted to the selector 15a. The selector 15a selects one positive-side PWM pattern from among the plurality of positive-side PWM patterns PTP, based on the gradation data Xi. In addition to the gradation data Xi+1, a plurality of negative-side PWM patterns PTM generated by the PWM pattern generating circuit 12 are inputted to the selector 15b. The selector 15b selects one negative-side PWM pattern from among the plurality of negative-side PWM patterns PTM, based on the gradation data Xi+1.

To the charge and discharge control circuit 16a are inputted the control signal ZC and the positive-side PWM pattern selected by the selector 15a. The charge and discharge circuit 17a is a CMOS switch including two transistors 171 and 172. By control of the charge and discharge control circuit 16a, an output voltage from the charge and discharge circuit 17a becomes a positive-side charge voltage VP during the charge period, and becomes a discharge voltage (ground voltage) during the discharge period. During the voltage holding period, the output from the charge and discharge circuit 17a is in a high impedance state.

The output voltage from the charge and discharge circuit 17a is outputted outside the data signal line drive circuit 10 through the polarity selecting circuit 18. An output voltage from the data signal line drive circuit 10 changes, for example, as shown in FIG. 3 (c). FIG. 3 (c) shows changes in an output voltage from the data signal line drive circuit 10 for the above-described three gradations. For example, in case of gradation L1, the output voltage from the data signal line drive circuit 10 changes to VP at time t11 and changes to zero at time t4. Note, however, that the output from the data signal line drive circuit 10 is in a high impedance state during time t2 to t4.

A data signal line Si functions as a load on the data signal line drive circuit 10. The load is, as shown in FIG. 4, modeled as a CR distributed constant circuit. When the output voltage from the data signal line drive circuit 10 changes in a stepwise manner, the voltage on the data signal line Si changes by the integral operation of the CR distributed constant circuit. Hence, the voltage on the data signal line Si changes as shown in FIG. 3 (d). FIG. 3 (d) shows changes in the voltage on the data signal line Si for the above-described three gradations. For example, in case of gradation L1, the voltage on the data signal line Si starts rising at time t11, stops the rise at time t2, and becomes substantially constant during time t2 to t4. The voltage on the data signal line Si starts falling at time t4 and returns to zero before long.

To the charge and discharge control circuit 16b are inputted the control signal ZC and the negative-side PWM pattern selected by the selector 15b. The charge and discharge circuit 17b is a CMOS switch including two transistors 173 and 174. By control of the charge and discharge control circuit 16b, an output voltage from the charge and discharge circuit 17b becomes a negative-side charge voltage VM during the charge period, and becomes the discharge voltage during the discharge period. During the voltage holding period, the output from the charge and discharge circuit 17b is in a high impedance state. The output voltage from the data signal line drive circuit 10 and the voltage on the data signal line Si+1 change in opposite directions to those in FIGS. 3 (c) and (d).

The voltage on the data signal line Sj is written to one of the pixel circuits 5 in the j-th column that is selected by the scanning signal line drive circuit 4. As described above, the length of the high-level period of the PWM pattern is determined according to the gradation and the polarity of the gradation voltage. Hence, according to the gradation, the charge time of the data signal line varies and the voltage after charging (the voltage at time t2; hereinafter, referred to as a reached voltage) also varies. For example, in FIG. 3, in case of gradation L1, the data signal line Si is charged for time T1 and the reached voltage is V1. In case of gradation L2 (L2<L1), the data signal line is charged for time T2 (T2<T1) and the reached voltage is V2 (V2<V1). Therefore, by suitably determining the length of the high-level period of the PWM pattern according to the gradation and the polarity of the gradation voltage, gradation voltages according to a video signal are applied to the data signal lines, by which gradation display can be performed.

According to the pulse width modulation driving described above, the data signal lines are driven without using analog buffer circuits, by which the power consumption of the data signal lines can be reduced. However, in general, there are variations in the time constant at charging of the data signal lines. Due to this, the data signal lines cannot be driven accurately only by the above-described method. Hence, as shown below, the data signal line drive circuit 10 according to the present embodiment uses a plurality of sets of PWM patterns associated with combinations of a gradation and the polarity of a gradation voltage.

The PWM pattern generating circuit 12 generates, for each gradation, a plurality of sets of PWM patterns having a cycle of one horizontal period and having a pulse width according to the gradation. More specifically, the PWM pattern generating circuit 12 generates 2^{q} sets (q is an integer greater than or equal to 1) of PWM patterns. One set of PWM patterns includes 2^{p} positive-side PWM patterns and 2^{p} negative-side PWM patterns for 2^{p} gradations. The PWM pattern generating circuit 12 outputs 2^{p+q+1} PWM patterns including 2^{p+q} positive-side PWM patterns PTP and 2^{p+q} negative-side PWM patterns PTM.

The PWM patterns generated by the PWM pattern generating circuit 12 change to a high level at different times during one horizontal period, and change to a low level at the same time during one horizontal period. Such PWM patterns can be defined using only the change timing to a high level. As shown in FIG. 5, the PWM pattern generating circuit 12 stores the change timings to a high level (hereinafter, referred to as ON timings) for all PWM patterns. The ON timing represents, for example, time from the start of one horizontal period until the PWM pattern changes to a high level, by a predetermined accuracy. The PWM pattern generating circuit 12 may fixedly store the ON timings or may rewritably store the ON timings.

When one ON timing is represented by d bits, the total amount of data on the ON timings stored in the PWM pattern generating circuit 12 is (2^{p+q+1}×d) bits. The PWM pattern generating circuit 12 has a function of changing a corresponding PWM pattern to a high level when time indicated by an ON timing has elapsed from the start of one horizontal period, and a function of changing all PWM patterns to a low level at time t3. The configuration of the PWM pattern generating circuit 12 may be arbitrary as long as the PWM pattern generating circuit 12 has those functions.

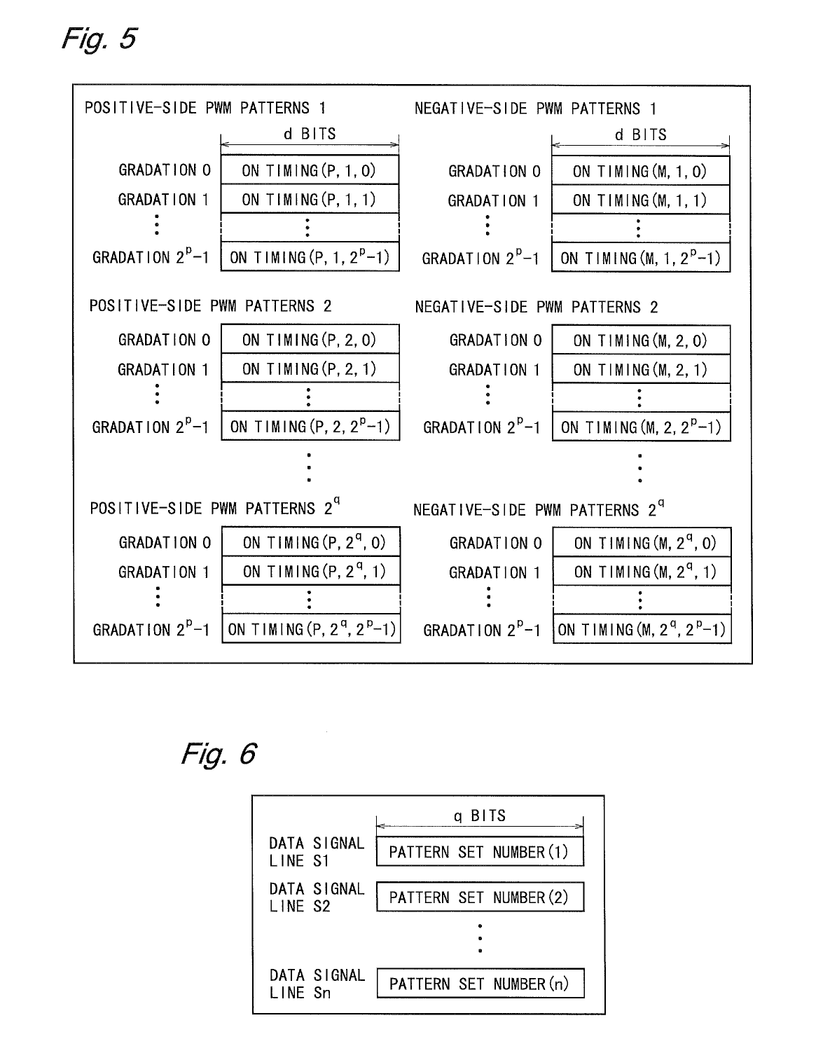

The PWM pattern specifying circuit 14 specifies, for each data signal line, which one of the 2^{q} sets of PWM patterns to use. More specifically, as shown in FIG. 6, the PWM pattern specifying circuit 14 stores, for each data signal line Sj, the set number of a PWM pattern to use (hereinafter, referred to as a pattern set number Yj) among the 2^{q} sets of PWM patterns. One pattern set number is represented by q bits, and the total amount of data on the pattern set numbers stored in the PWM pattern specifying circuit 14 is (n×q) bits. The pattern set numbers are determined by, for example, measuring the display gradations of the liquid crystal panel 2, and are stored rewritably in the PWM pattern specifying circuit 14.

The data register 11 outputs n gradation data X1 to Xn in parallel. At the first writing, the data register 11 outputs gradation data Xi to the selector 15a, and outputs gradation data Xi+1 to the selector 15b. In addition, at the second writing, the data register 11 outputs the gradation data Xi+1 to the selector 15a, and outputs the gradation data Xi to the selector 15b.

The PWM pattern specifying circuit 14 outputs n pattern set numbers Y1 to Yn in accordance with the output manner of the gradation data X1 to Xn. At the first writing, the PWM pattern specifying circuit 14 outputs a pattern set number Yi to the selector 15a, and outputs a pattern set number Yi+1 to the selector 15b. In addition, at the second writing, the PWM pattern specifying circuit 14 outputs the pattern set number Yi+1 to the selector 15a, and outputs the pattern set number Yi to the selector 15b.

The selectors 15a and 15b each function as a selecting circuit that selects one pattern from among the patterns generated by the PWM pattern generating circuit 12, based on the gradation data provided to each data signal line and the set of patterns specified for each data signal line. More specifically, to the selector 15a are inputted 2^{p+q} positive-side PWM patterns PTP, gradation data (p bits) outputted from the data register 11, and a pattern set number (q bits) outputted from the PWM pattern specifying circuit 14. The selector 15a selects one PWM pattern from among the 2^{p+q} positive-side PWM patterns PTP, using the gradation data and the pattern set number as selection control signals. Likewise, to the selector 15b are inputted 2^{p+q} negative-side PWM patterns PTM, gradation data outputted from the data register 11, and a pattern set number outputted from the PWM pattern specifying circuit 14. The selector 15b selects one PWM pattern from among the 2^{p+q} negative-side PWM patterns PTM, using the gradation data and the pattern set number as selection control signals. The charge and discharge circuit 17a is a CMOS switch in which the P-type transistor 171 and the N-type transistor 172 are connected in series. The positive-side charge voltage VP is fixedly applied to the source terminal of the transistor 171, and the source terminal of the transistor 172 is grounded. The charge and discharge circuit 17a outputs a drain terminal voltage of the transistors 171 and 172. The charge and discharge circuit 17b is a CMOS switch in which the P-type transistor 173 and the N-type transistor 174 are connected in series. The source terminal of the transistor 173 is grounded, and the negative-side charge voltage VM is fixedly applied to the source terminal of the transistor 174. The charge and discharge circuit 17b outputs a drain terminal voltage of the transistors 173 and 174. The transistors 171 and 174 each function as a charging transistor that applies a charge voltage to the data signal line according to a charge control signal. The transistors 172 and 173 each function as a discharging transistor that applies a discharge voltage to the data signal line according to a discharge control signal.

The charge and discharge control circuit 16a controls the charge and discharge circuit 17a, based on the control signal ZC and the PWM pattern selected by the selector 15a. More specifically, the charge and discharge control circuit 16a obtains a charge control signal to be provided to the gate terminal of the transistor 171 and a discharge control signal to be provided to the gate terminal of the transistor 172, based on the control signal ZC and the selected PWM pattern. During the charge period, the charge and discharge control circuit 16a controls the transistor 171 to an ON state and controls the transistor 172 to an OFF state. At this time, the charge and discharge circuit 17a outputs the positive-side charge voltage VP. During the discharge period, the charge and discharge control circuit 16a controls the transistor 171 to an OFF state and controls the transistor 172 to ON state. At this time, the charge and discharge circuit 17a outputs the discharge voltage (ground voltage). During the voltage holding period, the charge and discharge control circuit 16a controls both of the transistors 171 and 172 to an OFF state. At this time, an output from the charge and discharge circuit 17a is in a high impedance state.

The charge and discharge control circuit 16b controls the charge and discharge circuit 17b, based on the control signal ZC and the PWM pattern selected by the selector 15b. More specifically, the charge and discharge control circuit 16b obtains a discharge control signal to be provided to the gate terminal of the transistor 173 and a charge control signal to be provided to the gate terminal of the transistor 174, based on the control signal ZC and the selected PWM pattern. During the charge period, the charge and discharge control circuit 16b controls the transistor 173 to an OFF state and controls the transistor 174 to an ON state. At this time, the charge and discharge circuit 17b outputs the negative-side charge voltage VM. During the discharge period, the charge and discharge control circuit 16b controls the transistor 173 to an ON state and controls the transistor 174 to an OFF state. At this time, the charge and discharge circuit 17b outputs the discharge voltage (ground voltage). During the voltage holding period, the charge and discharge control circuit 16b controls both of the transistors 173 and 174 to an OFF state. At this time, an output from the charge and discharge circuit 17b is in a high impedance state.

The polarity selecting circuit 18 switches which output voltages from the charge and discharge circuits 17a and 17b are applied to which data signal lines Si and Si+1, according to polarity control signals PC1 and PC2. The polarity selecting circuit 18 includes four switches 181 to 184. The switch 181 is provided between the output of the charge and discharge circuit 17a and the data signal line Si, the switch 182 is provided between the output of the charge and discharge circuit 17a and the data signal line Si+1. The switch 183 is provided between the output of the charge and discharge circuit 17b and the data signal line Si. The switch 184 is provided between the output of the charge and discharge circuit 17b and the data signal line Si+1. The switches 181 and 184 are placed in an ON state when the polarity control signal PC1 is at a high level. The switches 182 and 183 are placed in an ON state when the polarity control signal PC2 is at a high level.

At the first writing, the polarity control signal PC1 is controlled to a high level and the polarity control signal PC2 is controlled to a low level. At this time, the output voltage from the charge and discharge circuit 17a is applied to the data signal line Si, and the output voltage from the charge and discharge circuit 17b is applied to the data signal line Si+1. At the second writing, the polarity control signal PC1 is controlled to a low level and the polarity control signal PC2 is controlled to a high level. At this time, the output voltage from the charge and discharge circuit 17a is applied to the data signal line Si+1, and the output voltage from the charge and discharge circuit 17b is applied to the data signal line Si.

As such, the charge and discharge circuit 17a applies the positive-side charge voltage VP and the discharge voltage to either one of the data signal lines Si and Si+1 in a switching manner, according to the charge control signal and the discharge control signal which are obtained by the charge and discharge control circuit 16a. In addition, the charge and discharge circuit 17b applies the negative-side charge voltage VM and the discharge voltage to either one of the data signal lines Si and Si+1 in a switching manner, according to the charge control signal and the discharge control signal which are obtained by the charge and discharge control circuit 16b.

As described above, the data signal line drive circuit 10 according to the present embodiment performs pulse width modulation driving where two types of voltages (a charge voltage and a discharge voltage) are applied to a data signal line in a switching manner. By this, without using analog buffer circuits through which a steady-state current flows, the data signal lines can be driven with low power consumption and gradation display can be performed. In addition, by suitably determining the length of a charge period for each gradation, desired γ characteristics can be achieved without using a γ converting circuit. Therefore, the power consumption of the data signal line drive circuit can also be reduced by not providing the γ converting circuit.

In addition, the data signal line drive circuit 10 according to the present embodiment generates a plurality of sets of PWM patterns associated with each gradation, and selects, for each data signal line, which set of PWM patterns to use. By this, even when there are variations in the time constant at charging of the data signal lines, the data signal lines can be driven accurately using suitable PWM patterns. In addition, according to the liquid crystal display device 1 according to the present embodiment, gradations can be displayed accurately using the data signal line drive circuit 10 capable of driving the data signal lines accurately.

Note that when the time constant at charging of the data signal line is τ, if the charge time of the data signal line is set to 2τ, then the reached voltage is about 86.5% of the charge voltage. If the charge time of the data signal line is set to 2.3τ, then the reached voltage is about 90% of the charge voltage. Hence, even if the charge time of the data signal line is set to 2τ or more, or 2.3τ or more, the voltage on the data signal line does not change to the extent that the charge time is extended. Therefore, when pulse width modulation driving is performed, it is preferred that the charge time of the data signal line be set to 2τ or less, or 2.3τ or less. By this, wasted charge time is reduced, enabling to use time effectively. In addition, it is preferred that one horizontal period be 4.5τ or more. By this, sufficient time can be secured to allow the voltage on the data signal line to reach a plurality of levels during one horizontal period.

### Second Embodiment

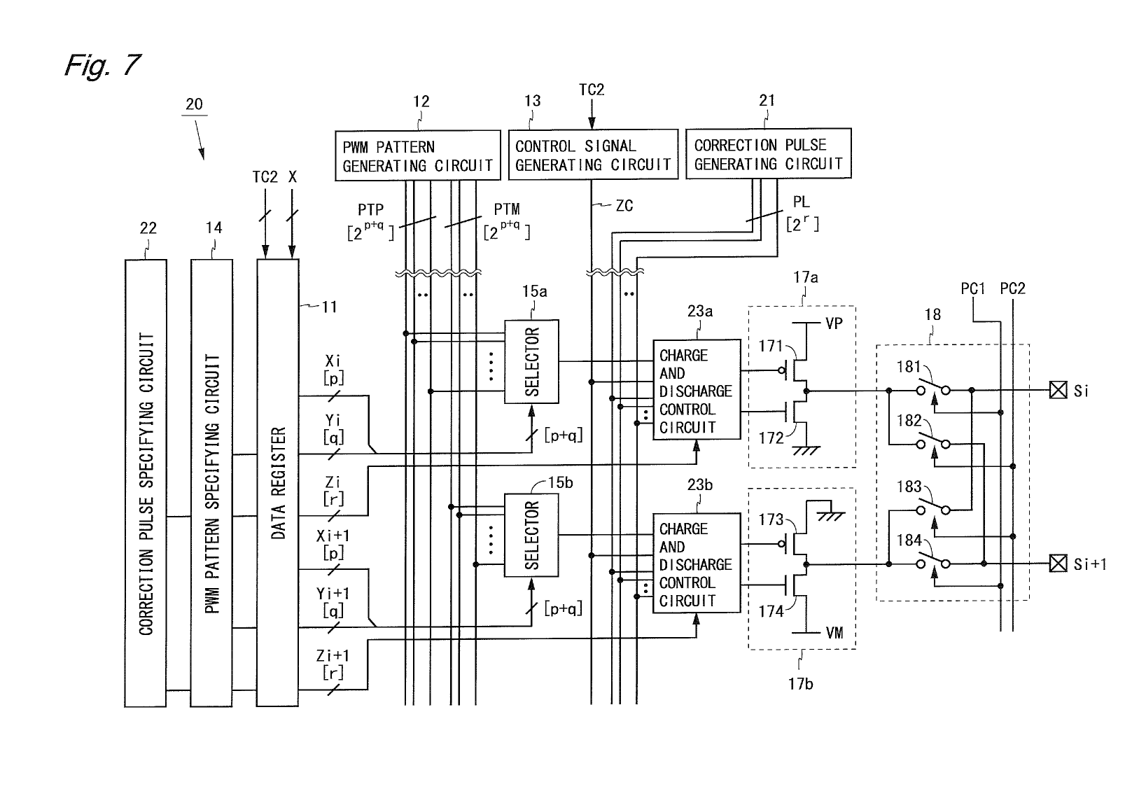

A liquid crystal display device according to a second embodiment of the present invention has the same configuration as the liquid crystal display device 1 (FIG. 1) according to the first embodiment. The liquid crystal display device according to the second embodiment includes a data signal line drive circuit 20 shown in FIG. 7, instead of the data signal line drive circuit 10. Of the components according to the present embodiment, the same components as those in the first embodiment are denoted by the same reference characters and description thereof is omitted.

FIG. 7 is a diagram showing a configuration of the data signal line drive circuit 20. As shown in FIG. 7, the data signal line drive circuit 20 is configured such that a correction pulse generating circuit 21 and a correction pulse specifying circuit 22 are added to the data signal line drive circuit 10 according to the first embodiment, and the charge and discharge control circuits 16a and 16b are replaced by charge and discharge control circuits 23a and 23b.

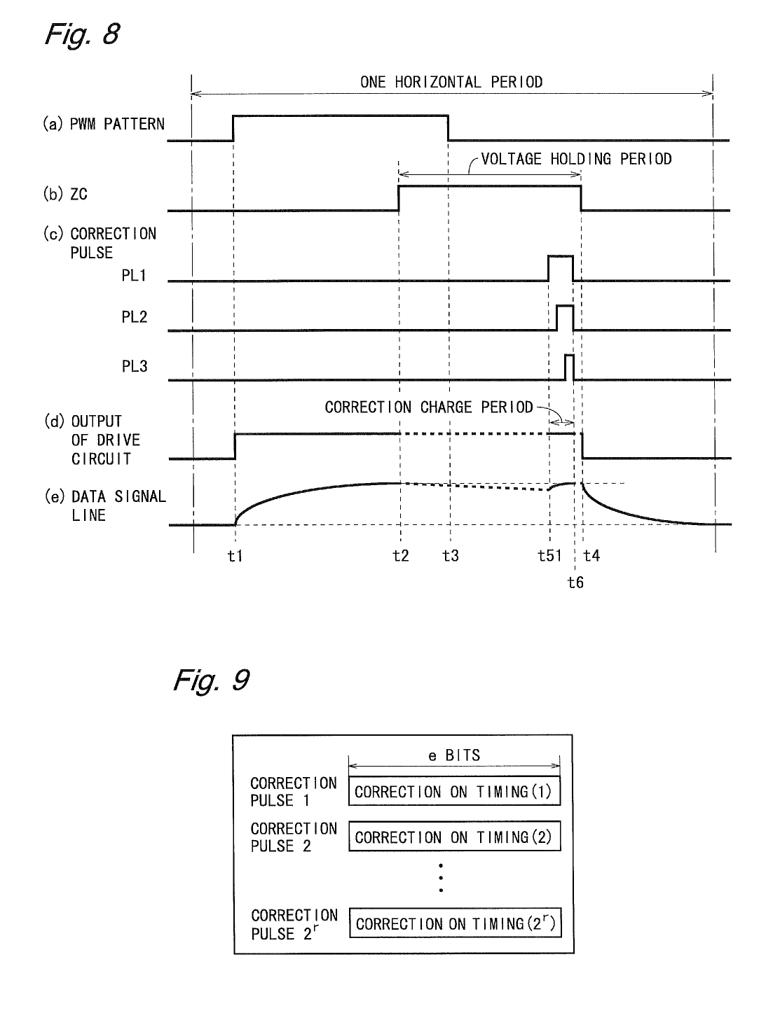

FIG. 8 is a signal waveform diagram of the data signal line drive circuit 20. With reference to FIGS. 7 and 8, the operation of the data signal line drive circuit 20 will be described. The correction pulse generating circuit 21 generates a plurality of types of correction pulses having a cycle of one horizontal period and having a predetermined pulse width. More specifically, the correction pulse generating circuit 21 generates 2^{r} (r is an integer greater than or equal to 1) correction pulses PL. FIG. 8 (c) shows three types of correction pulses PL1, PL2, and PL3. The correction pulse generated by the correction pulse generating circuit 21 changes to a high level at a predetermined time (e.g., time t51 in case of the correction pulse PL1) during a voltage holding period, and changes to a low level at time t6 during the voltage holding period. Note, however, that the correction pulse changes to a high level later than time t3. Time t6 is set immediately before time t4.

The correction pulses PL generated by the correction pulse generating circuit 21 change to a high level at different times during one horizontal period, and change to a low level at the same time during one horizontal period. Such correction pulses can be defined using only the change timing to a high level. As shown in FIG. 9, the correction pulse generating circuit 21 stores the change timings to a high level (hereinafter, referred to as correction ON timings) for all correction pulses. The correction ON timing represents, for example, time from the start of one horizontal period until the correction pulse changes to a high level, by a predetermined accuracy. The correction pulse generating circuit 21 may fixedly store the correction ON timings or may rewritably store the correction ON timings.

When one correction ON timing is represented by e bits, the total amount of data on the correction ON timings stored in the correction pulse generating circuit 21 is (2^{r}×e) bits. The correction pulse generating circuit 21 has a function of changing a corresponding correction pulse to a high level when time indicated by a correction ON timing has elapsed from the start of one horizontal period, and a function of changing all correction pulses to a low level at time t6. The configuration of the correction pulse generating circuit 21 may be arbitrary as long as the correction pulse generating circuit 21 has those functions.

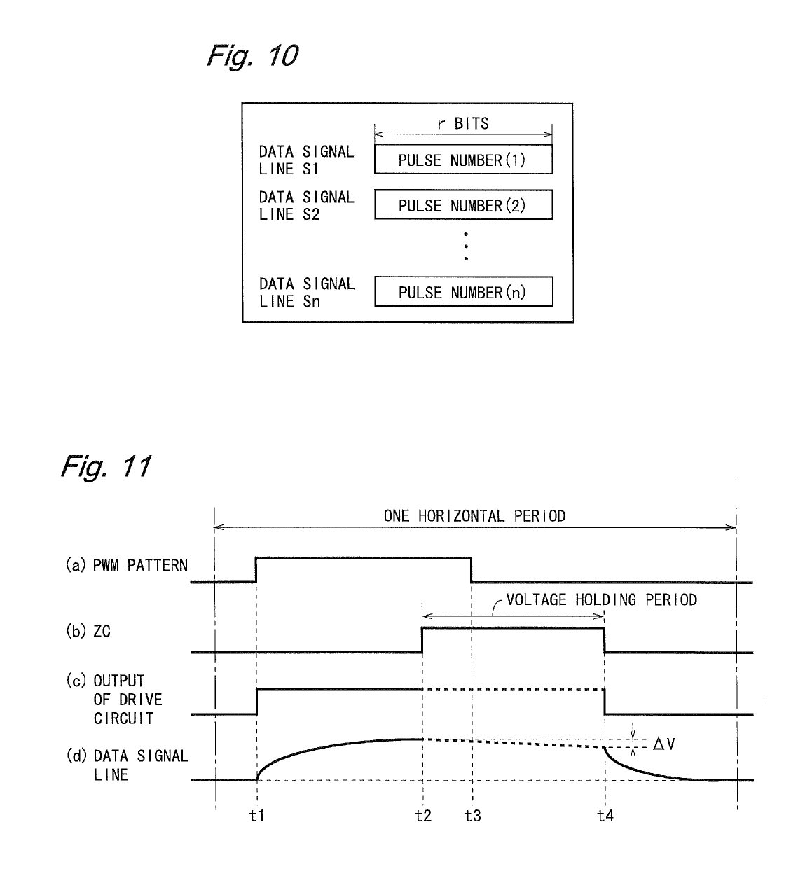

The correction pulse specifying circuit 22 specifies, for each data signal line, which one of the 2^{r} correction pulses to use. More specifically, as shown in FIG. 10, the correction pulse specifying circuit 22 stores, for each data signal line Sj, the number of a correction pulse to use (hereinafter, referred to as a pulse number Zj) among the 2^{r} correction pulses. One pulse number is represented by r bits, and the total amount of data on the pulse numbers stored in the correction pulse specifying circuit 22 is (n×r) bits. The pulse numbers are determined by, for example, measuring the display gradations of the liquid crystal panel 2, and are stored rewritably in the correction pulse specifying circuit 22.

The correction pulse specifying circuit 22 outputs n pulse numbers Z1 to Zn in accordance with the output manner of gradation data X1 to Xn. At the first writing, the correction pulse specifying circuit 22 outputs a pulse number Zi to the charge and discharge control circuit 23a, and outputs a pulse number Zi+1 to the charge and discharge control circuit 23b. In addition, at the second writing, the correction pulse specifying circuit 22 outputs the pulse number Zi+1 to the charge and discharge control circuit 23a, and outputs the pulse number Zi to the charge and discharge control circuit 23b. Note that FIG. 7 shows the state at the first writing.

To the charge and discharge control circuit 23a are inputted the control signal ZC, a PWM pattern selected by the selector 15a, the 2^{r} correction pulses PL generated by the correction pulse generating circuit 21, and a pulse number (r bits) outputted from the correction pulse specifying circuit 22. The charge and discharge control circuit 23a includes a selector (not shown). The selector selects one correction pulse from among the 2^{r} correction pulses PL, using the pulse number as a selection control signal. The period during which the selected correction pulse is at a high level is hereinafter referred to as a correction charge period.

The charge and discharge control circuit 23a controls the charge and discharge circuit 17a, based on the correction pulse selected therein, the control signal ZC, and the PWM pattern selected by the selector 15a. During the charge period and the correction charge period, the charge and discharge control circuit 23a controls the transistor 171 to an ON state and controls the transistor 172 to an OFF state. At this time, the charge and discharge circuit 17a outputs the positive-side charge voltage VP. During the discharge period, the charge and discharge control circuit 23a controls the transistor 171 to an OFF state and controls the transistor 172 to an ON state. At this time, the charge and discharge circuit 17a outputs the discharge voltage (ground voltage). During the voltage holding period, except the correction charge period, the charge and discharge control circuit 23a controls both of the transistors 171 and 172 to an OFF state. At this time, an output from the charge and discharge circuit 17a is in a high impedance state.

To the charge and discharge control circuit 23b are inputted the control signal ZC, a PWM pattern selected by the selector 15b, the 2^{r} correction pulses PL generated by the correction pulse generating circuit 21, and a pulse number outputted from the correction pulse specifying circuit 22. As with the charge and discharge control circuit 23a, the charge and discharge control circuit 23b selects one correction pulse from among the 2^{r} correction pulses PL, using a selector.

The charge and discharge control circuit 23b controls the charge and discharge circuit 17b, based on the correction pulse selected therein, the control signal ZC, and the PWM pattern selected by the selector 15b. During the charge period and the correction charge period, the charge and discharge control circuit 23b controls the transistor 173 to an OFF state and controls the transistor 174 to an ON state. At this time, the charge and discharge circuit 17b outputs the negative-side charge voltage VM. During the discharge period, the charge and discharge control circuit 23b controls the transistor 173 to an ON state and controls the transistor 174 to an OFF state. At this time, the charge and discharge circuit 17b outputs the discharge voltage (ground voltage). During the voltage holding period, except the correction charge period, the charge and discharge control circuit 23b controls both of the transistors 173 and 174 to an OFF state. At this time, an output from the charge and discharge circuit 17b is in a high impedance state.

As such, the charge and discharge control circuit 23a, 23b selects one correction pulse from among the 2^{r} correction pulses generated by the correction pulse generating circuit 21, based on a pulse number specified for each data signal line, and changes a charge control signal to be provided to the transistor 171, 174 to a level that instructs charging, based on the selected correction pulse.

Output voltages from the charge and discharge circuits 17a and 17b are outputted outside the data signal line drive circuit 20 through the polarity selecting circuit 18. An output voltage from the data signal line drive circuit 20 changes, for example, as shown in FIG. 8 (d). FIG. 8 (d) shows a change in an output voltage from the data signal line drive circuit 20 for when the correction pulse PL1 is selected. The output voltage from the data signal line drive circuit 20 changes to VP at time t1 and changes to zero at time t4. Note, however, that the output from the data signal line drive circuit 20 is in a high impedance state during time t2 to t51 and time t6 to t4. As such, the output voltage from the data signal line drive circuit 20 is equal to the positive-side charge voltage VP during time t51 to t6.

The voltage on the data signal line Si changes as shown in FIG. 8 (e). FIG. 8 (e) shows a change in the voltage on the data signal line Si for when the correction pulse PL1 is selected. The voltage on the data signal line Si starts rising at time t1 and stops the rise at time t2. It is ideal that the voltage on the data signal line Si be constant after time t2. However, actually, there is a possibility that a leakage current may flow through the data signal line Si. When the leakage current flows, the voltage on the data signal line Si decreases gradually after time t2.

When the leakage current flows, if a correction charge period is not provided, then as shown in of FIG. 11 (d), the voltage on the data signal line decreases by ΔV at time t4 compared with that at time t2. Hence, in a data signal line drive circuit that does not have a correction charge period, it is impossible to drive data signal lines accurately when the amount of decrease in voltage ΔV is large.

To solve this problem, in the data signal line drive circuit 20 according to the present embodiment, a correction charge period is provided near the end of a voltage holding period. During the correction charge period, the data signal line drive circuit 20 outputs the same voltage as that outputted during the charge period and thereby the potential of the data signal line is corrected, in the example shown in FIG. 8 (e), the voltage on the data signal line Si rises again during time t51 to t6 and reaches, at time t4, the same level as that at time t2.

The amount of decrease in voltage caused by a leakage current varies from data signal line to data signal line Sj. Meanwhile, when taking a look at one data signal line, the amount of decrease in voltage caused by a leakage current is substantially constant, regardless of the applied voltage. Taking into account those facts, the data signal line drive circuit 20 according to the present embodiment generates a plurality of types of correction pulses PL each having a predetermined width and selects, for each data signal line, which correction pulse to use. By this, even when the voltage on a data signal line changes due to a leakage current, by making a correction using a suitable correction pulse, the data signal line can be driven accurately.

### Third Embodiment

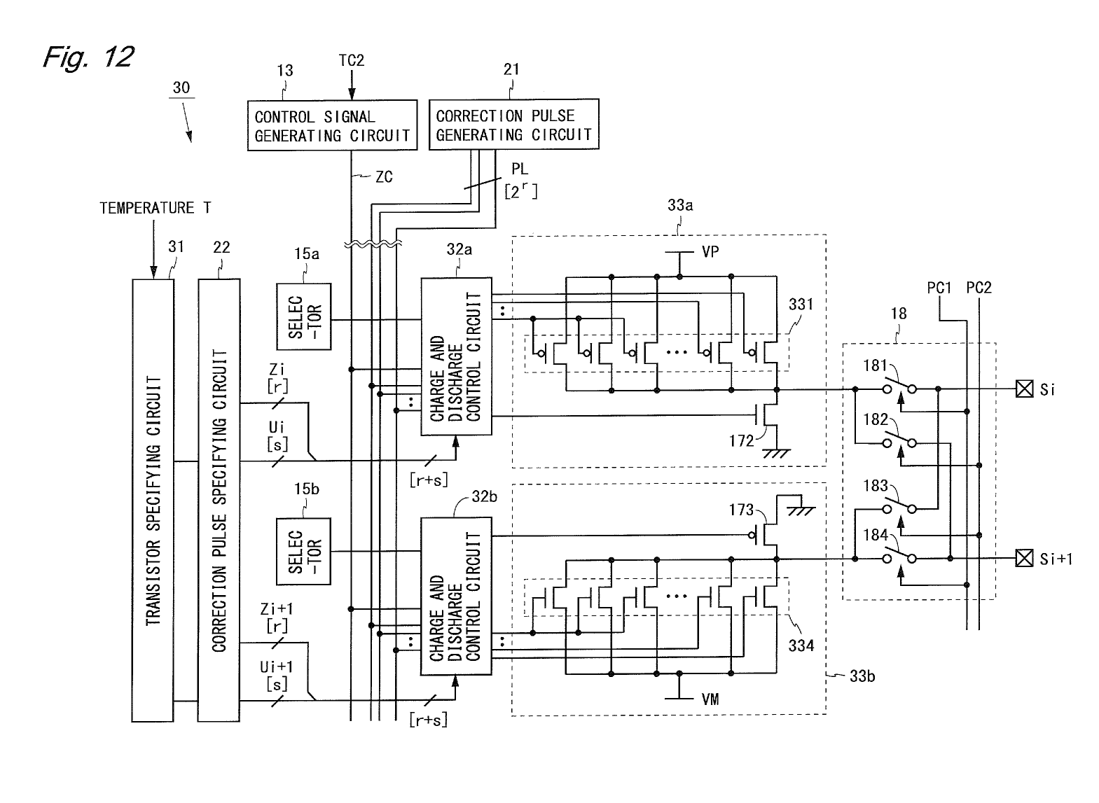

A liquid crystal display device according to a third embodiment of the present invention has the same configuration as the liquid crystal display device 1 (FIG. 1) according to the first embodiment. The liquid crystal display device according to the third embodiment includes a data signal line drive circuit 30 shown in FIG. 12, instead of the data signal line drive circuit 10. Of the components according to the present embodiment, the same components as those in the first and second embodiments are denoted by the same reference characters and description thereof is omitted.

FIG. 12 is a diagram showing a configuration of the data signal line drive circuit 30. As shown in FIG. 12, the data signal line drive circuit 30 is configured such that a transistor specifying circuit 31 is added to the data signal line drive circuit 20 according to the second embodiment, and the charge and discharge control circuits 23a and 23b and the charge and discharge circuits 17a and 17b are replaced by charge and discharge control circuits 32a and 32b and charge and discharge circuits 33a and 33b, respectively. Note that the data register 11, the PWM pattern generating circuit 12, and the PWM pattern specifying circuit 14 are omitted in FIG. 12.

The charge and discharge circuit 33a is a CMOS switch in which a plurality of P-type transistors 331 are connected in parallel and the N-type transistor 172 is connected in series with the P-type transistors 331. The positive-side charge voltage VP is fixedly applied to the source terminals of all of the transistors 331, and the source terminal of the transistor 172 is grounded. The charge and discharge circuit 33a outputs a drain terminal voltage of the transistors 331 and 172. The charge and discharge circuit 33b is a CMOS switch in which a plurality of N-type transistors 334 are connected in parallel and the P-type transistor 173 is connected in series with the N-type transistors 334. The source terminal of the transistor 173 is grounded, and the negative-side charge voltage VM is fixedly applied to the source terminals of all of the transistors 334. The charge and discharge circuit 33b outputs a drain terminal voltage of the transistors 173 and 334.

The plurality of transistors 331 include those of different sizes and those controlled using the same control signal. The plurality of transistors 334 are also the same as the transistors 331. In the following, the plurality of transistors 331 are controlled using a total of s (s is an integer greater than or equal to 2) control signals, and the plurality of transistors 334 are also the same as the transistors 331.

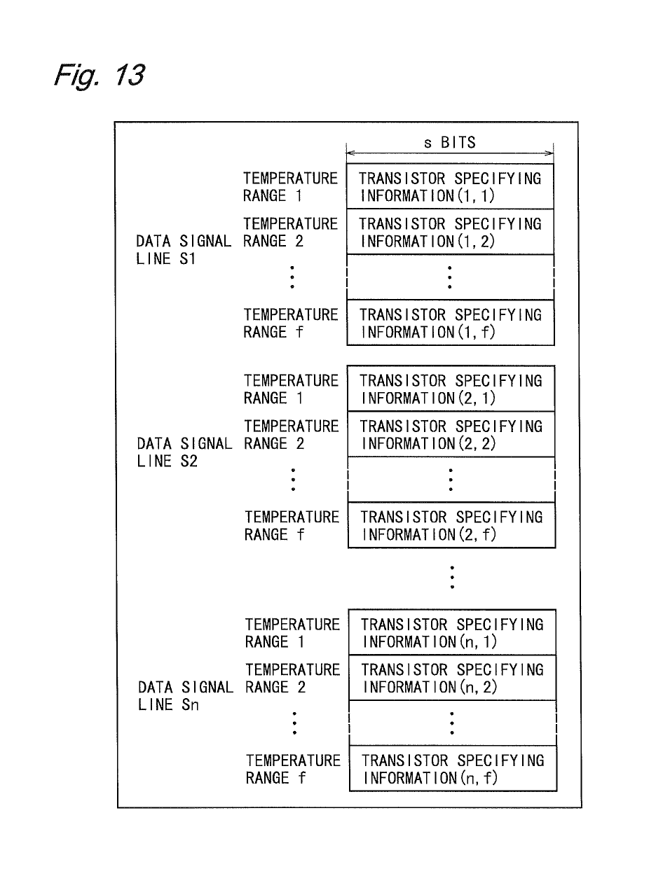

The transistor specifying circuit 31 specifies, for each data signal line, which transistor to use from among the plurality of transistors 331 and 334, according to the temperature. More specifically, as shown in FIG. 13, the transistor specifying circuit 31 stores, for each data signal line Sj and f temperature ranges, data specifying a transistor to use (hereinafter, referred to as transistor specifying information Uj) from among the plurality of transistors 331 and 334. The transistor to be used is specified using a control signal to be provided to the gate terminal. One transistor specifying information is represented by s bits, and the total amount of data on the transistor specifying information stored in the transistor specifying circuit 31 is (n×f×s) bits. The transistor specifying information is determined by, for example, measuring the display gradations of the liquid crystal panel 2, and is stored rewritably in the transistor specifying circuit 31.

The transistor specifying circuit 31 receives a temperature T detected by a temperature sensor (not shown) provided in the liquid crystal display device. The transistor specifying circuit 31 determines a temperature range to which the temperature T belongs from among the f temperature ranges, and outputs n pieces of transistor specifying information U1 to Un in parallel which are associated with the determined temperature range.

The transistor specifying circuit 31 outputs the n pieces of transistor specifying information U1 to Un in accordance with the output manner of gradation data X1 to Xn. At the first writing, the transistor specifying circuit 31 outputs transistor specifying information Ui to the charge and discharge control circuit 32a, and outputs transistor specifying information Ui+1 to the charge and discharge control circuit 32b. In addition, at the second writing, the transistor specifying circuit 31 outputs the transistor specifying information Ui+1 to the charge and discharge control circuit 32a, and outputs the transistor specifying information Ui to the charge and discharge control circuit 32b. Note that FIG. 12 shows the state at the first writing.

To the charge and discharge control circuit 32a is inputted transistor specifying information (s bits) outputted from the transistor specifying circuit 31, in addition to the control signal ZC, a PWM pattern selected by the selector 15a, 2^{r} correction pulses PL generated by the correction pulse generating circuit 21, and a pulse number (r bits) outputted from the correction pulse specifying circuit 22. During the charge period and the correction charge period, the charge and discharge control circuit 32a controls one or more transistors specified by the transistor specifying information among the plurality of transistors 331 to an ON state, and controls the remaining transistors 331 and the transistor 172 to an OFF state. At this time, the charge and discharge circuit 33a outputs the positive-side charge voltage VP. During the discharge period, the charge and discharge control circuit 32a controls all of the transistors 331 to an OFF state and controls the transistor 172 to an ON state. At this time, the charge and discharge circuit 33a outputs the discharge voltage (ground voltage). During the voltage holding period, the charge and discharge control circuit 32a controls all of the transistors 331 and the transistor 172 to an OFF state. At this time, an output from the charge and discharge circuit 33a is in a high impedance state.

To the charge and discharge control circuit 32b is inputted transistor specifying information outputted from the transistor specifying circuit 31, in addition to the control signal ZC, a PWM pattern selected by the selector 15b, the 2^{r} correction pulses PL generated by the correction pulse generating circuit 21, and a pulse number outputted from the correction pulse specifying circuit 22. During the charge period and the correction charge period, the charge and discharge control circuit 32b controls one or more transistors specified by the transistor specifying information among the plurality of transistors 334 to an ON state, and controls the remaining transistors 334 and the transistor 173 to an OFF state. At this time, the charge and discharge circuit 33b outputs the negative-side charge voltage VM. During the discharge period, the charge and discharge control circuit 32b controls the transistor 173 to an ON state and controls all of the transistors 334 to an OFF state. At this time, the charge and discharge circuit 33b outputs the discharge voltage (ground voltage). During the voltage holding period, the charge and discharge control circuit 32b controls the transistor 173 and all of the transistors 334 to an OFF state. At this time, an output from the charge and discharge circuit 33b is in a high impedance state.

In general, the impedance of transistors included in a charge and discharge circuit in a data signal line drive circuit changes greatly by temperature. Hence, in a data signal line drive circuit that performs pulse width modulation driving, the reached voltage of a data signal line changes by temperature. Therefore, when the temperature is changed, the data signal lines may not be able to be driven accurately.

To solve this problem, the data signal line drive circuit 30 according to the present embodiment includes the charge and discharge circuits 33a and 33b each including a plurality of charging transistors, and selects, for each data signal line Sj, which charging transistor to use, according to the temperature. By this, even when the characteristics of the charging transistors change with a change in temperature, the data signal lines can be driven accurately using suitable charging transistors.

Note that although the data signal line drive circuit 30 shown in FIG. 12 is configured by adding the temperature correction function to the data signal line drive circuit 20 according to the second embodiment, the temperature correction function may be added to the data signal line drive circuit 10 according to the first embodiment.

### Fourth Embodiment

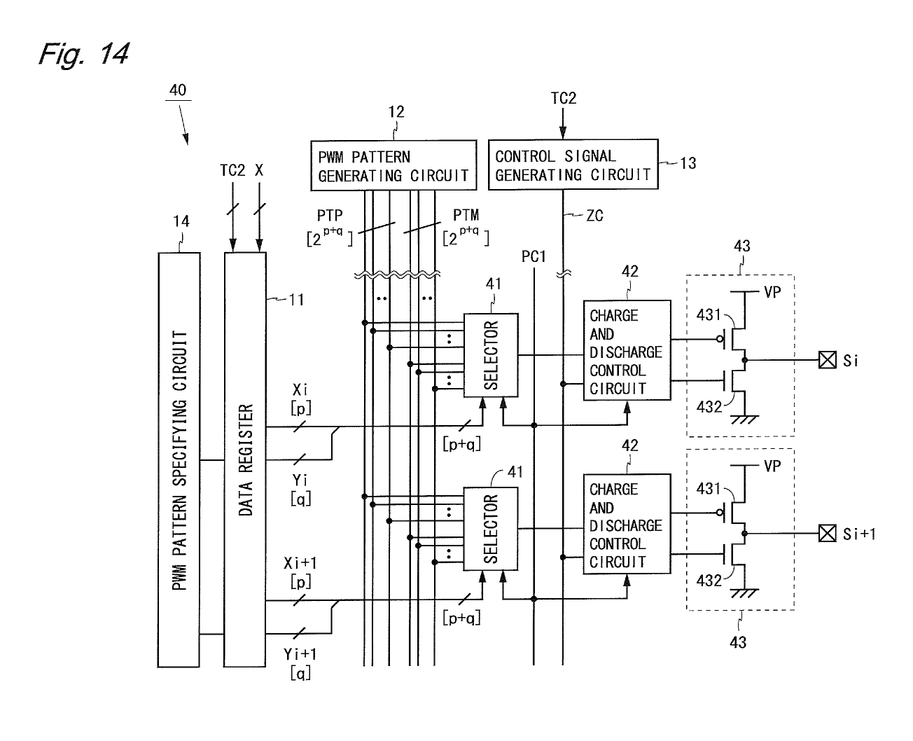

A liquid crystal display device according to a fourth embodiment of the present invention has the same configuration as the liquid crystal display device 1 (FIG. 1) according to the first embodiment. The liquid crystal display device according to the fourth embodiment further includes a counter electrode drive circuit (not shown) that drives a counter electrode of the liquid crystal panel 2, and includes a data signal line drive circuit 40 shown in FIG. 14 instead of the data signal line drive circuit 10. Of the components according to the present embodiment, the same components as those in the first embodiment are denoted by the same reference characters and description thereof is omitted.

The liquid crystal display device according to the present embodiment performs one-line reversal driving where the polarity of gradation voltages written to the pixel circuits 5 is reversed on a row-by-row basis, and counter-reversal driving where a voltage applied to the counter electrode of the liquid crystal panel 2 is switched between a relatively low level and a relatively high level. Writing positive polarity voltages to the pixel circuits 5 with applying a low-level voltage to the counter electrode of the liquid crystal panel 2 is hereinafter referred to as first writing, and writing negative polarity voltages to the pixel circuits 5 with applying a high-level voltage to the counter electrode of the liquid crystal panel 2 is hereinafter referred to as second writing.

FIG. 14 is a diagram showing a configuration of the data signal line drive circuit 40. As shown in FIG. 14, the data signal line drive circuit 40 includes the data register 11, the PWM pattern generating circuit 12, the control signal generating circuit 13, the PWM pattern specifying circuit 14, n selectors 41, n charge and discharge control circuits 42, and n charge and discharge circuits 43. The selectors 41, the charge and discharge control circuits 42, and the charge and discharge circuits 43 are provided in one-to-one correspondence with data signal lines Sj, and apply gradation voltages according to gradation data Xj outputted from the data register 11, to their corresponding data signal lines Sj.

To the selector 41 are inputted 2^{p+q} positive-side PWM patterns PTP, 2^{p+q} negative-side PWM patterns PTM, gradation data (p bits) outputted from the data register 11, a pattern set number (q bits) outputted from the PWM pattern specifying circuit 14, and the polarity control signal PC1. The selector 41 selects one PWM pattern from among the 2^{p+q} positive-side PWM patterns PTP and the 2^{p+q} negative-side PWM patterns PTM, using the gradation data, the pattern set number, and the polarity control signal PC1 as selection control signals.

As with the charge and discharge circuit 17a, the charge and discharge circuit 43 is a CMOS switch in which a P-type transistor 431 and an N-type transistor 432 are connected in series. A voltage VP is fixedly applied to the source terminal of the transistor 431, and the source terminal of the transistor 432 is grounded. The charge and discharge circuit 43 outputs a drain terminal voltage of the transistors 431 and 432.

The charge and discharge control circuit 42 controls the charge and discharge circuit 43, based on the control signal ZC, the polarity control signal PC1, and a PWM pattern selected by the selector 41. More specifically, the charge and discharge control circuit 42 obtains a first control signal to be provided to the gate terminal of the transistor 431 and a second control signal to be provided to the gate terminal of the transistor 432, based on the three provided signals. During a charge period at first writing and a discharge period after the first writing, the charge and discharge control circuit 42 controls the transistor 431 to an ON state and controls the transistor 432 to an OFF state. At this time, the charge and discharge circuit 43 outputs the voltage VP. During a charge period at second writing and a discharge period after the second writing, the charge and discharge control circuit 42 controls the transistor 431 to an OFF state and controls the transistor 432 to an ON state. At this time, the charge and discharge circuit 43 outputs the ground voltage. During a voltage holding period, the charge and discharge control circuit 42 controls both of the transistors 431 and 432 to an OFF state. At this time, an output from the charge and discharge circuit 43 is in a high impedance state.

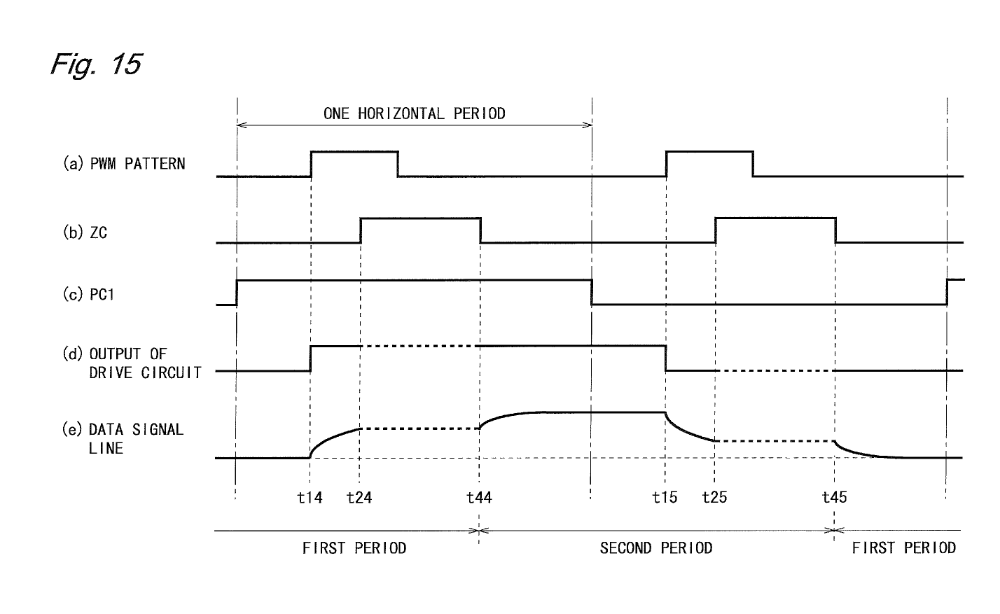

FIG. 15 is a signal waveform diagram of the data signal line drive circuit 40. The period from when the control signal ZC changes to a low level during a horizontal period where the second writing is performed, until the control signal ZC changes to a low level during a horizontal period where the first writing is performed is hereinafter referred to as a “first period”, and the period from when the control signal ZC changes to a low level during a horizontal period where the first writing is performed, until the control signal ZC changes to a low level during a horizontal period where the second writing is performed is hereinafter referred to as a “second period”. The period during which the PWM pattern is at a high level and the control signal ZC is at a low level during the first period is a charge period at first writing. The period during which the PWM pattern and the control signal ZC are at a low level during the second period is a discharge period after first writing. The period during which the PWM pattern is at a high level and the control signal ZC is at a low level during the second period is a charge period at second writing. The period during which the PWM pattern and the control signal ZC are at a low level during the first period is a discharge period after second writing.

In FIG. 15, time t14 to t24 serves as a charge period at first writing, and time t44 to t15 serves as a discharge period after the first writing. When the time at which the PWM pattern changes to a high level next is t16, time t15 to t25 serves as a charge period at second writing, and time t45 to t16 serves as a discharge period after the second writing. The voltage on the data signal line Si starts rising at time t14, stops the rise at time t24, becomes substantially constant during time t24 to t44, starts rising again at time t44, and becomes equal to the voltage VP before time t15 at the latest. Thereafter, the voltage on the data signal line Si starts falling at time t15, stops the fall at time t25, becomes substantially constant during time t25 to t45, starts falling again at time t45, and becomes zero before time t16 at the latest.

As such, during the discharge period after the first writing, the voltage on the data signal line Si further rises and becomes equal to the voltage VP eventually. During the discharge period after the second writing, the voltage on the data signal line Si further falls and becomes zero eventually. Therefore, when second writing is performed after first writing, the voltage on the data signal line Si can be allowed to reach a desired level by changing the voltage from the voltage VP, and when first writing is performed after second writing, the voltage on the data signal line Si can be allowed to reach a desired level by changing the voltage from zero.

In the present embodiment, the first control signal which controls the transistor 431 is a charge control signal during the first period, and is a discharge control signal during the second period. The second control signal which controls the transistor 432 is a discharge control signal during the first period, and is a charge control signal during the second period. The transistor 431 functions as a charging transistor or a discharging transistor according to the first control signal. The transistor 432 functions as a charging transistor or a discharging transistor according to the second control signal. According to the data signal line drive circuit 40 according to the present embodiment, when line-reversal driving and counter-reversal driving are performed, the same effects as those obtained in the first embodiment can be obtained.

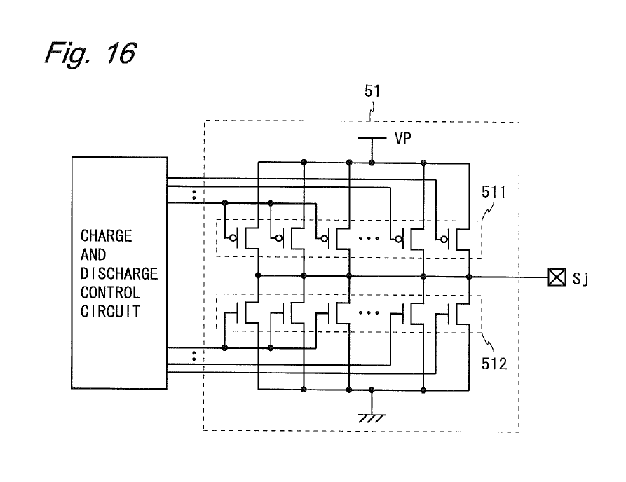

It has been described so far that when line-reversal driving and counter-reversal driving are performed, the method of the first embodiment is applied. However, when line-reversal driving and counter-reversal driving are performed, the method of the second or third embodiment may be applied. When the method of the third embodiment is applied, a charge and discharge circuit 51 shown in FIG. 16 is used. The charge and discharge circuit 51 is a CMOS switch in which a circuit in which a plurality of P-type transistors 511 are connected in parallel is connected in series with a circuit in which a plurality of N-type transistors 512 are connected in parallel. The charge and discharge circuit 51 includes the plurality of transistors 511 and the plurality of transistors 512. During a charge period at first writing, the charge and discharge circuit 51 uses one or more transistors specified for each data signal line Sj from among the plurality of transistors 511, according to the temperature. During a charge period at second writing, the charge and discharge circuit 51 uses one or more transistors specified for each data signal line Sj from among the plurality of transistors 512, according to the temperature. By this, even when the temperature is changed, the data signal line Sj can be driven accurately by using a suitable charging transistor for each data signal line Sj.

For the data signal line drive circuits according to the embodiments of the present invention, variants shown below can be configured. In the data signal line drive circuits according to the above-described embodiments, the PWM pattern generating circuit 12 generates a PWM pattern that goes to a high level once during one horizontal period. Instead of this, the PWM pattern generating circuit may generate a PWM pattern that goes to a high level twice or more during one horizontal period. In this case, the PWM pattern generating circuit stores, for each PWM pattern, one or more sets of change timings to a high level and a low level, in addition to the ON timings shown in FIG. 5. By this, a change in the voltage on a data signal line can be controlled more accurately, enabling to drive the data signal line more accurately. Note, however, that to reduce the power consumption of the data signal lines, it is preferred that the number of changes in PWM pattern be small. The present invention can also be applied to various types of display devices that perform gradation display, in addition to liquid crystal display devices.

As described above, according to the data signal line drive circuits of the present invention, the power consumption can be reduced by performing pulse width modulation driving, and the data signal lines can be driven accurately by performing various types of corrections. In addition, according to the display devices of the present invention, gradations can be displayed accurately using the data signal line drive circuits of the present invention.

### INDUSTRIAL APPLICABILITY

The drive circuits of the present invention have a feature that they can drive data signal lines accurately using pulse width modulation driving, and thus, can be used as the drive circuits of various types of display devices such as liquid crystal display devices.

### DESCRIPTION OF REFERENCE CHARACTERS

1: LIQUID CRYSTAL DISPLAY DEVICE
2: LIQUID CRYSTAL PANEL
3: DISPLAY CONTROL CIRCUIT
4: SCANNING SIGNAL LINE DRIVE CIRCUIT
5: PIXEL CIRCUIT
10, 20, 30, and 40: DATA SIGNAL LINE DRIVE CIRCUIT
11: DATA REGISTER
12: PWM PATTERN GENERATING CIRCUIT
13: CONTROL SIGNAL GENERATING CIRCUIT
14: PWM PATTERN SPECIFYING CIRCUIT
15 and 41: SELECTOR
16, 23, 32, and 42: CHARGE AND DISCHARGE CONTROL CIRCUIT
17, 33, 43, and 51: CHARGE AND DISCHARGE CIRCUIT
18: POLARITY SELECTING CIRCUIT
21: CORRECTION PULSE GENERATING CIRCUIT
22: CORRECTION PULSE SPECIFYING CIRCUIT
31: TRANSISTOR SPECIFYING CIRCUIT
171, 172, 173, 174, 331, 334, 431, 432, 511, and 512: TRANSISTOR
181, 182, 183, and 184: SWITCH

1. A drive circuit that drives data signal lines of a display device, the drive circuit comprising:
a pattern generating circuit that generates, for each gradation, a plurality of sets of patterns having a pulse width according to the gradation;
a selecting circuit that selects one pattern from among the patterns generated by the pattern generating circuit, based on gradation data provided to each of the data signal lines and a set of patterns specified for each of the data signal lines;
a charge and discharge control circuit that obtains a charge control signal and a discharge control signal, based on the pattern selected by the selecting circuit; and
a charge and discharge circuit that applies a charge voltage and a discharge voltage to the data signal line in a switching manner, according to the charge control signal and the discharge control signal.

2. The drive circuit according to claim 1, wherein the charge and discharge circuit includes a charging transistor that applies the charge voltage to the data signal line, according to the charge control signal; and a discharging transistor that applies the discharge voltage to the data signal line, according to the discharge control signal.

3. The drive circuit according to claim 2, further comprising a correction pulse generating circuit that generates a plurality of types of correction pulses each having a predetermined width, wherein
the charge and discharge control circuit selects one correction pulse specified for each of the data signal lines from among the correction pulses generated by the correction pulse generating circuit, and changes the charge control signal to a level that instructs charging, based on the selected correction pulse.

4. The drive circuit according to claim 2, wherein the charge and discharge circuit includes a plurality of charging transistors and uses, at charging, one or more transistors specified for each of the data signal lines from among the plurality of charging transistors, according to a temperature.

5. The drive circuit according to claim 2, wherein during a voltage holding period set in one horizontal period, the charge and discharge control circuit controls both of the charging transistor and the discharging transistor to an OFF state.

6. The drive circuit according to claim 2, wherein
the charge and discharge control circuit outputs a first control signal and a second control signal, the first control signal being the charge control signal during a first period and being the discharge control signal during a second period, and the second control signal being the discharge control signal during the first period and being the charge control signal during the second period, and
the charge and discharge circuit includes a first transistor that functions as the charging transistor or the discharging transistor according to the first control signal; and a second transistor that functions as the discharging transistor or the charging transistor according to the second control signal.

7. The drive circuit according to claim 6, wherein the charge and discharge circuit includes a plurality of first transistors and a plurality of second transistors, and uses, at charging during the first period, one or more transistors specified for each of the data signal lines from among the plurality of first transistors, according to a temperature, and uses, at charging during the second period, one or more transistors specified for each of the data signal lines from among the plurality of second transistors, according to the temperature.

8. The drive circuit according to claim 1, wherein charge time during one horizontal period of each of the data signal lines is twice a time constant at charging of the data signal line or less.

9. The drive circuit according to claim 1, wherein charge time during one horizontal period of each of the data signal lines is 2.3 times a time constant at charging of the data signal line or less.

10. The drive circuit according to claim 1, wherein one horizontal period is 4.5 times a time constant at charging of the data signal lines or more.

11. A display device that performs gradation display, the display device comprising:
a display panel including a plurality of scanning signal lines, a plurality of data signal lines, and a plurality of pixel circuits;
a scanning signal line drive circuit that selects the scanning signal lines in turn; and
a data signal line drive circuit that applies gradation voltages according to a video signal, to the data signal lines, wherein
the data signal line drive circuit includes:
a pattern generating circuit that generates, for each gradation, a plurality of sets of patterns having a pulse width according to the gradation;
a selecting circuit that selects one pattern from among the patterns generated by the pattern generating circuit, based on gradation data provided to each of the data signal lines and a set of patterns specified for each of the data signal lines;
a charge and discharge control circuit that obtains a charge control signal and a discharge control signal, based on the pattern selected by the selecting circuit; and
a charge and discharge circuit that applies a charge voltage and a discharge voltage to the data signal line in a switching manner, according to the charge control signal and the discharge control signal.

12. A drive method for driving data signal lines of a display device, the method comprising the steps of:
generating, for each gradation, a plurality of sets of patterns having a pulse width according to the gradation;
selecting one pattern from among the generated patterns, based on gradation data provided to each of the data signal lines and a set of patterns specified for each of the data signal lines;
obtaining a charge control signal and a discharge control signal, based on the selected pattern; and
applying a charge voltage and a discharge voltage to the data signal line in a switching manner, according to the charge control signal and the discharge control signal.

13. (canceled)
